(19) United States
(12) Patent Application Publication
(10) Pub. No.: US 2008/0060702 A1
(43) Pub. Date: Mar. 13, 2008

(54) ELLIPTICAL SCORE PATTERN FOR REVERSE ACTING STYLE RUPTURE DISC AND ASSEMBLY USING THE SAME

(76) Inventor: Scott Muddiman, Burlington (CA)

Correspondence Address: IAN FINCHAM, SUITE 606, 225 METCALFE STREET, OTTAWA, ON, K2P 1P9, US

(21) Appl. No.: 11/309,685

(22) Filed: Sep. 12, 2006

(51) Int. Cl. F16K 17/16

(52) U.S. Cl. 137/68.27

(57) ABSTRACT

A non-reclosing, over-pressure relief device comprising a unitary pressure support having a central dome including a convex surface and an opposed concave surface, a flange surrounding the dome, the flange including a transition portion joining the flange to the dome and an elliptically shaped blow-out portion included in the dome formed by at least one cut-through line of an elliptical shape. In a preferred embodiment, the blow-out portion has at least one connecting member connectably bridging the cut-through line to connect the blow-out portion to an adjacent portion of the dome to thereby retain the blow-out portion, and at least one pressure seal in juxtaposition with the device.

### FIELD OF THE INVENTION

The present invention relates to an overpressure relief device, and more particularly to a non-reclosing, over-pressure relief device or reverse rupture acting style disc having an elliptical cut-through line.

### BACKGROUND OF THE INVENTION

Rupture discs have been known in this art for many years. Normally, rupture discs are manufactured to have a rupturable membrane to provide a safety mechanism to relieve excessive pressure within a pressurized system or vessel. The rupture disc and or rupture disc assemblies are adapted to be attached to a system or vessel so as to prevent the flow of a liquid or a gas through such a device until the rupture disc, having a known weakness, ruptures through excessive or over-pressure loads. Generally speaking, rupture discs are pre-weakened by scoring, cutting, or, via other conventional methods, the pressure supporting membrane to enable the disc to fail at a predetermined pressure.

### SUMMARY OF THE INVENTION

With the present invention, it has been found that by providing an composite assembly including a dome shaped pressure support having a 345° generally elliptical, substantially cut-through pattern or line, a formed metal pressure support ring fitted to the concave side of the pressure support, and a pressure seal fitted to the convex side of the pressure support, that disadvantages of using solid metal disks with conventional pre-weakening methods are overcome as the novel assembly of the present invention permits a wider range of application for varying liquid and gas usages, and varying burst pressures.

Another aspect of the present invention to provide a domed pressure support in combination with a pressure support ring, the pressure support having a substantially cut-through pattern or line having a generally elliptical configuration. At least one or more interruptions in the substantially cut-through line may be provided to stabilize the dome portion of the support and control the tensile strength when desired.

A seal is provided on the convex side of the pressure support to prevent leakage of fluids or the like through the pressure support from the convex side. In addition an optional seal can be placed on the concave side of the pressure support to prevent leakage of fluids or the like through the support from the concave side.

In accordance with another aspect of the present invention, there is provided a non-reclosing, over-pressure relief device comprising a unitary pressure support having a central dome including a convex surface and an opposed concave surface, a flange surrounding the dome, the flange including a transition portion joining the flange to the dome, an elliptically shaped blow-out portion included in the dome formed by at least one cut-through line of an elliptical shape, and at least one pressure seal in juxtaposition with said device.

In a further aspect, there is provided a reverse acting style rupture disc and holder assembly incorporating the relief device together with a disc holding assembly including at least one assembly ring in juxtaposition with the device. Desirably, the above aspects further include a blow-out portion having at least one connecting member connectably bridging the cut-through line to connect the blow-out portion to an adjacent portion of the dome to thereby retain the blow-out portion in a desired position.

In another aspect of the present invention, there is provided in a reverse acting style rupture disc having an annual flat flange and a concave convex disc dome, the improvement wherein the disc comprises a dome portion having a generally elliptical cut-through score line extending between the concave and convex surfaces to form an elliptically shaped blow-out portion of the dome, the blow-out portion being connected by at least one connecting member connecting the blow-out portion to a non-blow-out portion of the dome.

### BRIEF DESCRIPTION OF THE DRAWINGS

FIG. 1 is a side view of a first embodiment of a disc assembly according to the present invention;

FIG. 2 is a top down view of a disc assembly illustrating an alternative embodiment of an elliptical score line and projection members;

FIG. 3 is an elevational exploded view of the components as illustrated in FIG. 2;

FIG. 4 is a side view of the components as illustrated in FIG. 2; and

FIG. 5 is an elevational view of the reverse bursting disc of FIG. 2 in a bursting member assembly.

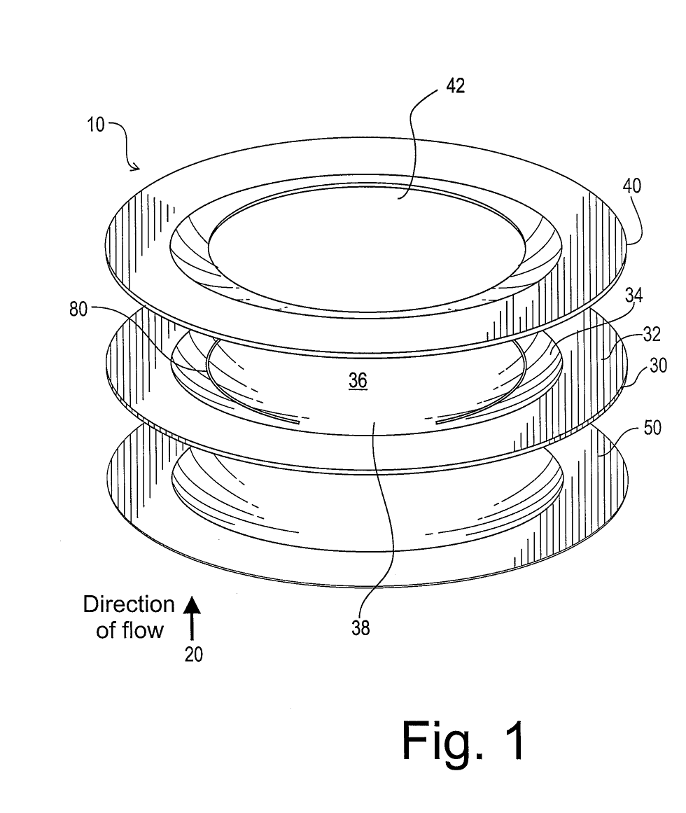

### DETAILED DESCRIPTION OF THE PREFERRED EMBODIMENT

In accordance with one aspect of the present invention, there is provided a reverse composite disc adapted to have an optimum relieving capacity, durability, low burst pressure and non-fragmentation in a reverse buckling design. In a preferred alternative embodiment, the disc (generally identified by reference numeral 10) is of a composite reverse acting design having at least three primary components, including a domed shaped pressure support 30, an outer rim portion or seat 32, a shoulder portion or transition radius 34, a dome 36 and a 345° (preferably) elliptical slot 80 or cut-through line or portion in the dome 36, defining a hinge member 38. A second component is a formed metal pressure support ring (generally identified as reference numeral 40) adapted to be fitted to the concave side of the dome shaped pressure support 30. The pressure support ring 40 includes a 360° elliptical cut out (generally identified as reference numeral 42), having a slightly smaller inside diameter than the elliptical slot 80 in the pressure support 30, which creates a ledge 44 for an edge of the pressure support to rest upon when assembled. A third component is pressure seal 50, which is adapted to be form fitted to the convex side of the pressure support 30. The various components and their preferred materials and/or manufacture are described in greater detail hereinbelow.

In use, the disc assembly (components 30, 40 and 50) is installed with the normal system pressure (direction of flow generally identified by reference numeral 20) applied to the convex side of the seal 50, which places the assembly into compression. As the system pressure increases, the dome 34 of the pressure support 30 becomes unstable, and eventually buckles due to the increased pressure, which allows the pressure support 30 to fold back through the support ring 40 and out of the way exposing the seal 50 to the full system pressure which overcomes the tensile strength of the seal material and subsequently bursts.

The elliptical cut 80 in the pressure support, which extends completely through the material (partially scored or otherwise partially cut) provides for a non-uniform collapse of the pressure support dome. The slot or cut-through 80 provides advantages over other design discs, discussed in greater detail below. A preferred range for the elliptical cut is between 270 and 355°, desirably 300 and 345°, and most preferably is 345°.

The elliptical cut 80 in the pressure support may include at least one or more interruptions or tabs to provide additional strength or support to the dome portion when desired. This additional feature is discussed in greater detail below.

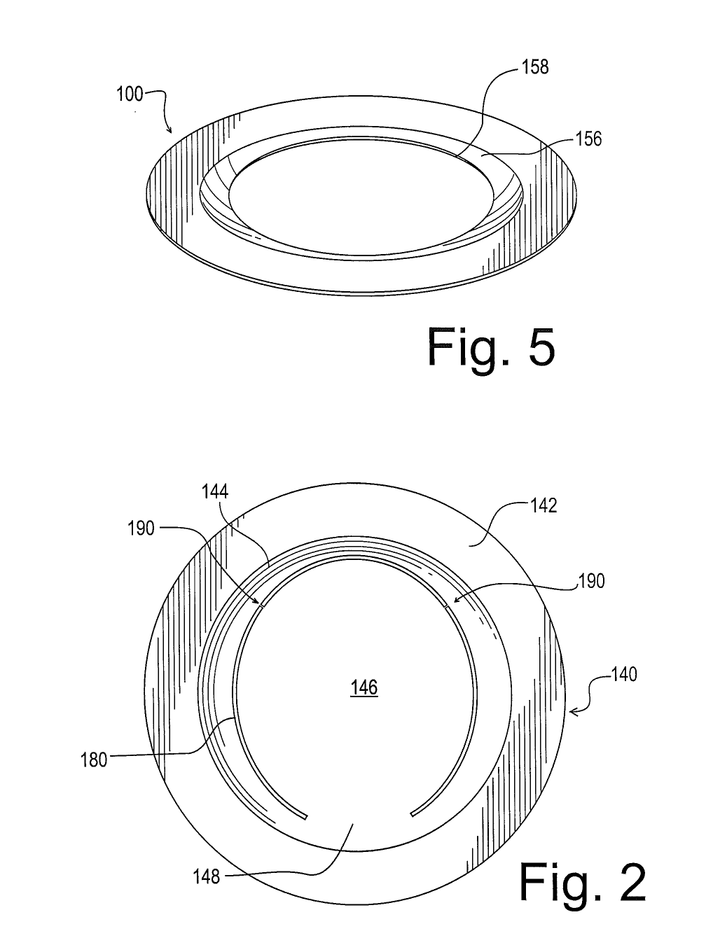

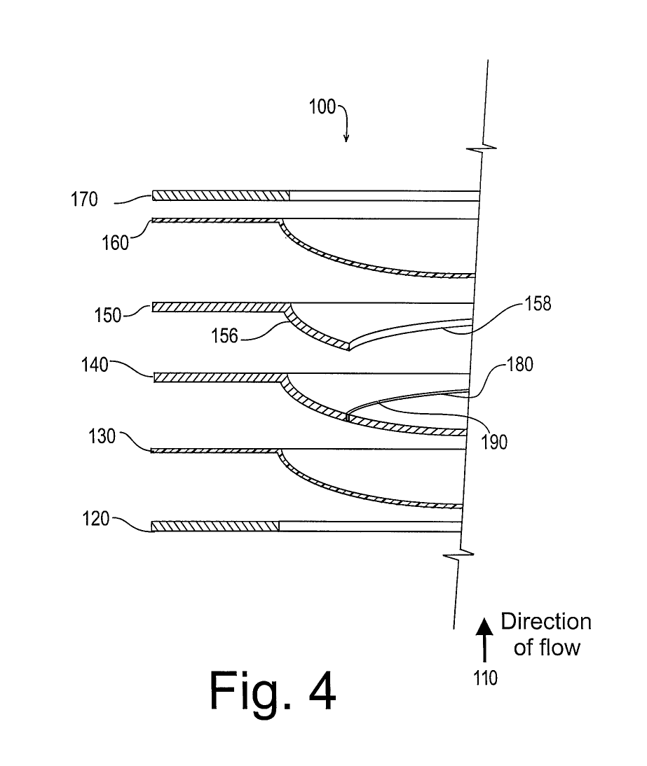

As illustrated in Drawing FIGS. 2 through 5, reference numeral 100 generally designates a non-reclosing over-pressure relief device according to a preferred embodiment of the present invention. The assembly 100 includes a lower assembly ring 120, a lower pressure seal 130, a dome shaped pressure support 140, a support ring 150, an upper pressure seal 160, and a top assembly ring 170.

When viewed from a pressure side to a non-pressure side of the rupture disc assembly 100, (i.e. from the convex to the concave side generally indicated by reference numeral 110), there is provided a lower assembly ring 120, which is positioned against the lower surface of a lower pressure seal 130. The lower assembly ring 120 may be constructed of any suitable material known in the art. The lower pressure seal 130, configured to be form fitted to the convex side of the support 140, is adapted to provide a secure seal against leakage between a pressure support 140 and the lower assembly ring 130, and ultimately to prevent leakage about or through the pressure support 140 when the complete system is in an assembled condition and placed within a pressured system. The lower and upper pressure seals 130 and 160, respectively, may be constructed from a conventional material, such as plastic, Teflon, metal, or other flexible material known in the art.

With reference to the dome shaped pressure support generally identified by reference numeral 140, the pressure support 140 is referred to as a reverse rupture acting style disc. The pressure support 140 may be constructed from any conventional material such as steel, steel alloys or other metals, and is adapted to open along a predetermined cut line, discussed in greater detail below. The pressure support 140, as illustrated in drawing FIG. 5, includes an outer rim portion or seat 142, a shoulder portion or transition radius 144, a dome portion 146 and a hinge or non-cut portion 148.

As illustrated in the drawing Figures, support 140 of the present invention includes an elliptical cut-through pattern or line 180, as illustrated in FIGS. 2 and 5. The cut-through line 180 is preferably a 345° elliptical slot in the dome portion 146 of the disc, although other suitable radii may be used as desired. The cut-through portion may preferably have a length of up to about 345°, preferably leaving a hinge or non-cut-through portion of about 15°. As will be understood by those skilled in the art, other radii may be used as desired in accordance with the teachings of the present invention.

In a preferred embodiment, the elliptical slot or cut-through pattern may include at least one or more non-cut out portions or interruptions, such as tabs 190, whereby tabs 190 or similar members are located in the elliptical slot or cut line. As illustrated, and for exemplary purposes only, the tabs 190 are located at a 10 and 2 o'clock orientation in relation to the hinge member 148. The tabs 190 are adapted to hold or maintain the dome shaped pressure support or disc 140 in the closed position on the support ring 150. Other orientations and number of tabs may be incorporated as desired, depending upon the strength or support desired in the pressure support.

The pressure support ring 150 includes an annular circumferential outer ring 152, and an annular flat seat or surface 154 which is adapted to receive the pressure support member 140. The support ring 150 further includes a circumferential raised inner rim or member 156, which is positioned inwardly of the outer ring 152. When in a fully assembled condition, the raised rim 156 is adapted to secure the pressure support 140 against the support ring 150. The support ring 150 includes a 360° opening pattern or elliptical cut out 158, having a slightly smaller inside diameter than that of the elliptical slot 180 of the pressure support dome which creates a ledge or support member for an edge of the dome portion of the pressure support 140 to rest upon. The inside diameter of the pressure support ring can be manufactured with razor sharp teeth or other similar means to assist in cutting the pressure seal open after the pressure support dome collapses and the pressure seal is pushed through the pressure support ring by the system pressure.

As illustrated in FIGS. 2, 3 and 4, the support ring 150 extends into the concave portion of the dome portion 146 of the pressure support 140. The opening pattern 158 is of a general elliptical shape, extending continuously on the inner peripheral portion of the supporting ring 150 and which depends from a horizontal plane of the supporting ring 150 towards and within the dome portion of the pressure support 140.

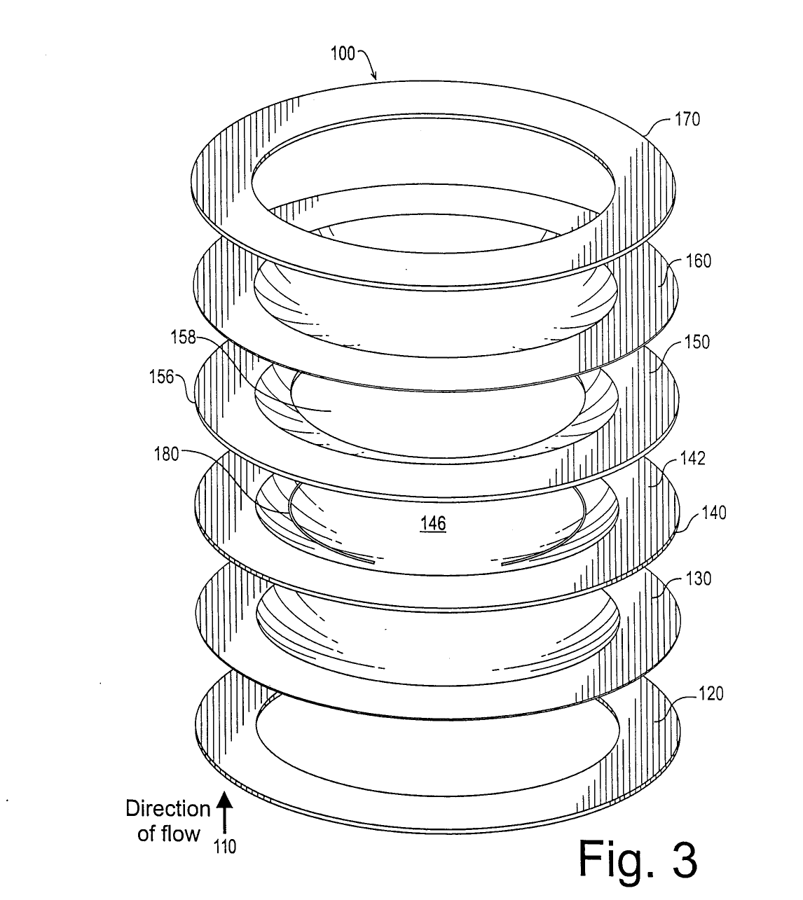

As best seen in drawing FIG. 3, an upper pressure seal 160 is provided between the support ring 160 and the upper support ring 170. As noted hereinabove, the upper pressure seal is adapted to provide a secure seal against backflow when exposed to vacuum or back pressure.

The top assembly ring 170 is provided to secure the safety device together when an assembled conditioned securing the various other components between the top assembly ring and the bottom assembly ring.

In use, the disc assembly 100 (including a holder, such as steel rings clamped on the seat, not shown) is attached to a pressure system (not shown) with the lower ring 120 placed towards the pressure flow, followed in sequential order by the lower pressure seal 130, the pressure support 140, the support ring 150, the upper pressure seal 160, and top assembly ring 170, such that any pressure must first contact the pressure seal 130. The disc assembly 100 is installed with the normal system pressure applied to the convex side of the dome, placing assembly into compression. As the system pressure increases, the dome of the pressure support disc becomes unstable and eventually buckles to the increased pressure, allowing the pressure support to fold back through the support ring and exposes the seal to the full system pressure which overcomes tensile strength of the sealing material and bursts.

More specifically, when a pressure in the system is greater than the designated rupture pressure of the rupture disc 140, the disc pressure load is exceeded and upon rupture, the pressure is relieved through the assembly 100 whereby the dome portion 146 of the pressure support 140 upon failure, reverses or collapses into itself about the elliptical cut 180 and “hinges” upon the non-cut portion of the support 140 over the support ring 150. Upon failure, the short side of the dome 146 collapses first, followed by the remainder of the pressure support 140, as a result of the non-uniform elliptical cut-through or line in the dome 146. The seals 130 and 150, being of a flexible material and having a lower pressure failure, each reverses upon itself similar to the dome portion 146 and bursts. In use, when a pressure load exceeds the predetermined pressure load of the rupture disc 140, the dome is adapted to open along the elliptical cut-through line 180 and reverse fold back or hinge along the rim about the portion of the support ring 160.

Numerous advantages are associated with the novel elliptical cut-through or elliptical slit disc, such as the compression loaded structure allows for operation at pressure of up to 90% of its marked burst pressure. Further, the elliptical slot (12 or 80) or substantially cut-through line in the pressure support is much weaker than a score or other weakening means in conventional discs, which permits the use of much thicker material and a 20-30% lower dome heights, providing greater durability and corrosion resistance.

Further advantages also include ultra low reversible pressures with full and complete opening achieved due to the 20-30% lower dome heights, which is not available in other conventional reverse rupture discs. Further, the elliptical slot or cut-through pattern allows for the supporting dome to buckle or collapse non-uniformly and swing or otherwise hinge through the support ring without becoming hung up on the ring thus providing consistently greater relieving capacity.

Further, controlling the length of the elliptical slot or cut-through line up to a 345° maximum, leaves a strong 15% permanent hinge to retain the pressure support after bursts preventing fragmentation of the pressure support itself. This assembly may be manufactured to resist vacuum. Further, the support may be adapted to burst at both positive and negative pressures by adding an atmospheric seal and adjusting the strength of the tabs and the slot of the pressure support. Another advantage is that the disc may be used within all types of service, such as gas, liquid or two phase flow. The ratio of positive to negative burst pressure can be controlled if desired by adjusting the strength of the seal material and/or the strength of the tabs in the slot or slit portion of the disc in order to provide a fail safe design.

Although embodiments of the invention have been described above, it is not limited thereto and it will be apparent to those skilled in the art that numerous modifications form part of the present invention insofar as they do not depart from the spirit, nature and scope of the claimed and described invention.

What is claimed is:

1. A non-reclosing, over-pressure relief device comprising:
a unitary pressure support having a central dome including a convex surface and an opposed concave surface, a flange surrounding the dome, said flange including a transition portion joining the flange to the dome;
an elliptically shaped blow-out portion included in said dome formed by at least one cut-through line of an elliptical shape;
a pressure support ring adapted to be positioned on the concave surface of the pressure support; and
at least one pressure seal in juxtaposition with said pressure support.

2. The device as claimed in claim 1, wherein said blow-out portion has at least one connecting member connectably bridging said cut-through score line to connect said blow-out portion to an adjacent portion of said dome to thereby support said blow-out portion.

3. The device as claimed in claim 1, wherein said pressure seal comprises a thin flexible layer of material adapted to retain said elliptically shaped blow-out portion in juxtaposition with said support.

4. The device as claimed in claim 2, wherein said connecting member comprises a non-cut out portion or a tab.

5. The device as claimed in claim 1, wherein said at least one cut-through line includes at least one interruption.

6. A reverse acting style rupture disc and holder assembly incorporating the relief device as claimed in claim 1, together with a disc holding assembly including at least one assembly ring in juxtaposition with said device.

7. In a reverse acting style rupture disc having an annual flat flange and a concave convex disc dome, the improvement wherein the disc comprises:
a dome portion having a generally elliptical cut-through line extending between said concave and convex surfaces to form an elliptically shaped blow-out portion of the dome, the blow-out portion being connected by at least one connecting member connecting the blow-out portion to a non-blow-out portion of the dome.

8. A non-reclosing, over pressure relief assembly, the assembly comprising:
a lower assembly ring;
a lower pressure seal;
a dome shaped unitary pressure support having a central dome including a convex surface and an opposed concave surface;
a pressure support ring;
an upper pressure seal;
an upper assembly ring; and
wherein said dome includes an elliptically shaped blow-out portion formed by at least one cut-through line of an elliptical shape.

9. The assembly as claimed in claim 8, wherein said lower pressure seal is adapted to be form fitted to the convex side of the pressure support.

10. The assembly as claimed in claim 8, wherein said elliptical cut-through line includes at least one interruption.

11. The assembly as claimed in claim 10, wherein said at least one interruption reinforces said elliptically shaped blow-out portion.

12. The assembly as claimed in claim 8, wherein said elliptical cut-through line has a radius in the range of 270° to 355°.

13. The assembly as claimed in claim 12, wherein said range is preferably between 300° and 345°.

14. The assembly as claimed in claim 12, wherein said cut-through line is 345°.

15. The assembly as claimed in claim 10, further including a pair of interruptions, said pair of interruptions being oriented at a 10 and 2 o'clock position in relation to the non-cut-through portion.

16. The assembly as claimed in claim 8, wherein said pressure support ring includes an elliptical cut-out opening, having a slightly smaller inside diameter than that of the at least one cut-through line.

17. The assembly as claimed in claim 16, wherein the inside diameter of the pressure support ring further includes cutting means adapted to assist in cutting of the pressure seal.

18. The assembly as claimed in claim 17, wherein the cutting means includes teeth.

19. The assembly as claimed in claim 16, wherein the opening pattern of the cut-out is of a generally elliptical shape extending continuously along the inner peripheral portion of the supporting ring.

20. The assembly as claimed in claim 19, wherein the opening pattern depends from a horizontal plane of the supporting ring towards and within the dome portion of the pressure support.
